(19) United States
(12) Patent Application Publication
(10) Pub. No.: US 2024/0170900 A1
(43) Pub. Date: May 23, 2024

(54) ELECTRICAL CONNECTOR WITH MAGNETIC LOCKING OF A PIVOT JOINT BETWEEN TWO HOUSING PARTS

(71) Applicant: Phoenix Contact GmbH & Co. KG, Blomberg (DE)

(72) Inventors: Hrvoje Babic, Herrenberg (DE); Ralf Beckmann, Detmold (DE); Martin Schaefers, Paderborn (DE); Juergen Sahm, Ammerbuch (DE); Markus Hermann, Ammerbuch (DE); Markus Michel, Nagold (DE); Frank Brokmann, Detmold (DE); Holger Ritter, Wumberg (DE); Markus Hanses, Hoexter (DE)

(21) Appl. No.: 18/552,674

(22) PCT Filed: Mar. 25, 2022
(86) PCT No.: PCT/EP2022/057924

§ 371 Date: Dec. 4, 2023

(30) Foreign Application Priority Data
Mar. 29, 2021 (DE) DE102021107863.6

(51) Int. Cl. H01R 35/04

(52) U.S. Cl. CPC H01R 35/04

(57) ABSTRACT

An electrical connector includes: at least a first housing part and a second housing part, an engagement region of one of the first housing part and the second housing part engaging at least partially and concentrically with an other of the first housing part and the second housing part, the first housing part and the second housing part being rotatable in the engagement region relative to each other about an axis of rotation; at least one bolt disposed in the engagement region, which in a first basic state secures the first housing part and the second housing part against rotation of the housing parts relative to each other about the axis of rotation, and in a second basic state releases the housing parts. The at least one bolt is magnetic and preloaded by a spring force.

### CROSS-REFERENCE TO PRIOR APPLICATIONS

This application is a U.S. National Phase application under 35 U.S.C. § 371 of International Application No. PCT/EP2022/057924, filed on Mar. 25, 2022, and claims benefit to German Patent Application No. DE 10 2021 107 863.6, filed on Mar. 29, 2021. The International Application was published in German on Oct. 6, 2022 as WO/2022/207490 under PCT Article 21(2).

### FIELD

The invention relates to an electrical connector having at least a first housing part and a second housing part, wherein in an engagement region one of the housing parts engages at least partially and concentrically with the other housing part, and wherein the first housing part and the second housing part are configured to be rotatable in the engagement region relative to each other about an axis of rotation.

### BACKGROUND

Electrical connectors are known from the prior art which have two housing parts mounted so as to be rotatable relative to each other about a common axis of rotation, wherein one housing part engages at least partially with the other, and the two housing parts are fixed to each other, connected to the each other, or the like in the axial direction, i.e., in both possible directions parallel to the axis of rotation. A pivot joint is thus disposed between the first housing part and the second housing part, wherein the housing parts are typically themselves part of the pivot joint. This means that the pivot joint is not an explicit separate element or component of the electrical connector, but is formed substantially by means of the two housing parts. One of the housing parts engages in an engagement region with an inner cavity of the other housing part. The housing parts have a rotationally symmetrical basic shape at least in the engagement region, wherein the respective rotational symmetry axis coincides with the (common) axis of rotation. In the case of the one housing part plunging into or engaging with the other housing part, the rotational symmetry relates in particular to its outer design with regard to the outer circumferential wall in the engagement region and, with regard to the other housing part, with or into the inner cavity of which the one housing part engages or plunges, in particular the design of the inner cavity and an inner wall of the other housing part surrounding the inner cavity. When the one housing part is engaged with the other housing part, the two housing parts are accordingly disposed concentrically to each other in the engagement region. Outside the engagement region, it is not necessary to restrict the design of the housing parts or generally of the entire electrical connector of this type, optionally comprising further housing parts, further elements such as contact carriers for contacts, etc. In the axial direction parallel to the axis of rotation, the first and the second housing parts are fixed to each other, for example by means of a circlip, which engage in each case, for example, on stops acting in the opposite direction on the two housing parts and/or engage with recesses on the housing parts extending around the inside or outside, or the like. If necessary, the two housing parts are preloaded against each other by a spring force in an axial direction parallel to the axis of rotation. Such a configuration, as described above, is known in particular from right-angle connectors, wherein either the first housing part or the second housing part are angled or are at least part of an angled electrical connector housing as the totality of all housing parts on one side of the pivot joint.

A mutual axial fixing of the first housing part and the second housing part parallel to the axis of rotation furthermore allows a free rotation of the two housing parts relative to each other about the axis of rotation. However, free rotatability of the first housing part and the second housing part relative to each other about the axis of rotation is not necessarily desired and expedient.

### SUMMARY

In an embodiment, the present invention provides an electrical connector, comprising: at least a first housing part and a second housing part, an engagement region of one of the first housing part and the second housing part being configured to engage at least partially and concentrically with an other of the first housing part and the second housing part, the first housing part and the second housing part are configured to be rotatable in the engagement region relative to each other about an axis of rotation; at least one bolt disposed in the engagement region, which in a first basic state secures the first housing part and the second housing part against rotation of the housing parts relative to each other about the axis of rotation, and in a second basic state releases the housing parts, wherein the at least one bolt is magnetic and preloaded by a spring force, and a transition of the bolt from a first basic state to a second basic state is inducible by application of a magnetic force to the at least one bolt.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1: an exploded view of the essential elements of an embodiment variant of an electrical connector according to the invention;

FIG. 2: a three-dimensional isometric angular sectional view of the engagement region of a right-angle connector according to the invention in accordance with FIG. 1 with the bolt being in a first basic state; and

FIG. 3: a three-dimensional isometric angular sectional view of the engagement region of a right-angle connector according to the invention in accordance with FIGS. 1 and 2 with the bolt being in a second basic state.

### DETAILED DESCRIPTION

In an embodiment, the present invention provides an electrical connector in which a first housing part and a second housing part are connected to each other with a pivot joint so as to be rotatable relative to each other about an axis of rotation, and the first and the second housing part can be detachably fixed to each other with respect to a rotation relative to each other about the axis of rotation in at least one position or in a plurality of different positions.

According to that, at least one bolt is disposed in the engagement region, which in a first basic state secures the first housing part and the second housing part against rotation of the housing parts relative to each other about the axis of rotation, and in a second basic state releases said parts, wherein the bolt is magnetic and preloaded by a spring force, and the transition of the bolt from a first basic state to a second basic state can be induced by the application of a magnetic force to the bolt.

The pretensioning of the bolt by a spring force results in the bolt being in a first basic state or locking state by default, and in a second basic state or release state only by way of exception. The spring force on the bolt can be applied, for example, by means of a spring element which is mounted, for example, on and/or in one of the housing parts and acts on the bolt. A second basic state or release state can be achieved, starting from a first basic state or locking state, only by application of magnetic force and, if necessary, can be maintained for some time, wherein the application of magnetic force must correspondingly overcompensate the spring force in order to bring the bolt out of a position assumed by the bolt in a locking state into a position assumed in a release state. The application of magnetic force can result from the magnetic interaction between one or more permanent magnets and the bolt. As an alternative to the permanent magnet, the application of magnetic force can also result from interaction between an electromagnet and the bolt. For this purpose, the bolt is either made of a magnetic, preferably ferromagnetic and/or permanent magnetic material, or has at least one essential element, for example in the case of a multipart design of the bolt, which element is correspondingly magnetic, preferably ferromagnetic and/or permanently magnetic.

The permanent magnet can be an external element or can be part of an external element that is not part of an electrical connector according to the invention. However, the permanent magnet can also be disposed on the electrical connector. In this case, the permanent magnet must also assume at least two different positions and be movable between these positions, which correspond to two basic states of the permanent magnet: a magnetic release state in which the magnetic interaction between the permanent magnet and the bolt is so great as to result in application of magnetic force on the bolt that overcompensates the spring force and brings the bolt from a locking state into a release state and holds it there as long as the permanent magnet is in the magnetic release state, and a magnetic locking state. This can also be realized in various ways. For example, the permanent magnet can be removed far enough from the bolt so that the remaining (unavoidable, since it cannot be simply turned off and is also hard to insulate) remaining magnetic residual interaction between the permanent magnet and the bolt results in application of a magnetic force which remains significantly below application of a magnetic force that at least compensates for the spring force. Alternatively, the mutual orientation of the magnetic poles (short: the polarity) of the permanent magnet and of the bolt could be changed relative to each other, so that instead of a polarity which causes an attractive magnetic interaction and a corresponding application of force, a polarity results which causes a repulsive magnetic interaction and a corresponding application of force. In this case, the spring force would even be intensified by the magnetic interaction, but this is not a disadvantage for a locking state of the bolt. In this sense, an electromagnet disposed on the electrical connector would have a significant advantage over a permanent magnet for causing a magnetic interaction between the bolt and the electromagnet, since the electromagnet must only be connected differently for a change in state, whereas the permanent magnet must be, for example, moved and/or rotated for a change in state, for which purpose—if the permanent magnet is to be part of the electrical connector—corresponding means, elements, parts and/or the like must be provided on the electrical connector.

Basically, different locking states and also different release states can exist in relation to a bolt. All locking states have in common that in one of the locking states, the first housing part and the second housing part are secured in a rotationally fixed manner against rotation relative to each other about the axis of rotation by means of the bolt, and a rotation relative to each other about the axis of rotation is therefore not possible. Accordingly, all release states have in common that in one of the release states, the first housing part and the second housing part are released with respect to a rotation of the first housing part and the second housing part relative to each other about the axis of rotation by means of the bolt, and random rotations of the first housing part and the second housing part relative to each other about the axis of rotation are possible. The locking states and also the release states of a bolt can differ from one another in the respective locking state or release state, for example depending on the configuration of the respective positions of the bolt. Moreover, the locking states and also the release states of a bolt can differ from one another with respect to the position or angular position of the first housing part and the second housing part relative to each other with respect to a rotation of the first housing part and the second housing part relative to each other about the axis of rotation. The position or angular position is a specific relative position of the first housing part relative to the second housing part, or vice versa, in relation to a (usually arbitrarily selected or selectable) zero angle position as a reference for rotations of the first housing part and the second housing part relative to each other about the axis of rotation.

A plurality of bolts can be provided on an electrical connector according to the invention. The bolts can all be designed identically, but the bolts can also be designed differently. When the first housing part and the second housing part are fixed to each other in a rotationally fixed manner, the bolts can all interact in each case, but it is also possible for only some of them to interact or for them to act completely independently of one another. It can therefore be provided, for example, that a plurality of bolts are always simultaneously in a respective locking state when the first housing part and the second housing part are fixed to each other in a rotationally fixed manner, wherein all of the bolts also have to be brought simultaneously from the respective locking state into a respective release state so that the first housing part and the second housing part can rotate freely relative to each other about the axis of rotation. Alternatively, it can also be provided that only one bolt at a time is in a locking state and that all other bolts are each in a release state, wherein the first housing part and the second housing part are secured against rotation relative to each other about the axis of rotation by the one bolt in the locking state, and a rotation is not possible. Also, a distinction can be made, for example, between the cases where the other bolts or at least some of the other bolts could still be in a locking state (but are not, as this is not desired or necessary, for example), or where it is not possible for all or at least some of the other bolts to assume the locking state, since this is, for example, basically not provided for (in the design). In order to enable a free rotation of the first housing part and the second housing part relative to each other about the axis of rotation, the one bolt in the locking state must hence be brought into a release state. The first housing part and the second housing part can then be rotated freely relative to each other about the axis of rotation. By rotating the first housing part and the second housing part relative to each other about the axis of rotation can be brought from an angular position into a, for example, different angular position, in which a renewed mutual fixing of the first housing part and the second housing part against rotation relative to each other about the axis of rotation is possible by, in which at least one of the bolts is brought from a release state into a locking state. If an electrical connector according to the invention comprises a plurality of bolts, it can be provided that in certain angular positions of the first housing part and the second housing part, with respect to a rotation about the axis of rotation relative to each other, a plurality of bolts can simultaneously be brought from a release state into a locking state, provided that in this angular position a particularly high locking force is required when the first housing part and the second building part are fixed to each other in a rotationally fixed manner. However, in other angular positions, unless a particularly high locking force is required when the first housing part and the second building part are fixed to each other in a rotationally fixed manner, it can be provided that only one of the bolts is brought, or can be brought, from a release state into a locking state.

According to the invention and in the sense of a kinematic reversal, it can also be provided for the at least one bolt to be preloaded by a spring force in such a way that the bolt is, by default, in a second basic state or release state. A first basic state can then be achieved, starting from a second basic state, only by application of magnetic force and, if necessary, can be maintained for some time, wherein the application of magnetic force must correspondingly overcompensate the spring force in order to bring the bolt out of a position assumed by the bolt in a release state into a position assumed in a locking state. Such an embodiment of an electrical connector according to the invention is expedient in particular if the application of magnetic force is generated by the magnetic interaction of the bolt with a correspondingly connectable (energizable) electromagnet.

In a preferred embodiment variant of an electrical connector according to the invention, it is provided for the bolt to extend in a first basic state in the radial direction through a corresponding radial feedthrough from the housing part located outside in the engagement region into an inner cavity of the outside housing part and to further extend at least partially into a corresponding radial recess in the housing part located inside in the engagement region. When the bolt is engaged the radial recess of the inside housing part, the first housing part and the second housing part are secured in a rotationally fixed manner against rotation of the first housing part and second housing part relative to each other about the axis of rotation, regardless of which one of the two housing parts is the housing part located inside in the engagement region and which one is the outside housing part. The feedthrough for the bolt from the housing part located on the outside in the engagement region into its inner cavity and the radial recess of the inside housing part for the respective engagement of the bolt, and the bolt itself, are correspondingly designed to match each other. Depending on the design of the bolt and its mounting, fixing or the like in or on the housing part located outside in the engagement region, the bolt in the locking state can also extend completely from an outer wall of the outside housing part through the outside housing part to an inner wall which surrounds the inner cavity of the housing part located outside in the engagement region, and then further to the radial recess of the housing part located inside in the engagement region.

According to a preferred embodiment variant of an electrical connector according to the invention, the housing part located inside in the engagement region has a plurality of radial recesses disposed along the outer circumference. Thus, by means of one bolt, the first housing part and the second housing part can be secured in a rotationally fixed manner, in various angular positions, against rotation relative to each other about the axis of rotation. The number of possible corresponding angular positions which the two housing parts assume during rotation relative to each other about the axis of rotation and in which the housing parts can be fixed to each other in a rotationally fixed manner, is predetermined by the total number of radial recesses and their arrangement along the outer circumference of the housing part located inside in the engagement region.

An electrical connector according to the invention, designed in accordance with at least one of the above-described embodiment variants or according to any combination of the embodiment variants, allows for a very high locking force when the first housing part and the second housing part are fixed to each other in a rotationally fixed manner. In addition, such an electrical connector can be better sealed than electrical connectors known from the prior art with a pivot joint between a first housing part and a second housing part. Another advantage is high wear-free turning cycles during rotation of the first housing part and the second housing part relative to each other about the axis of rotation.

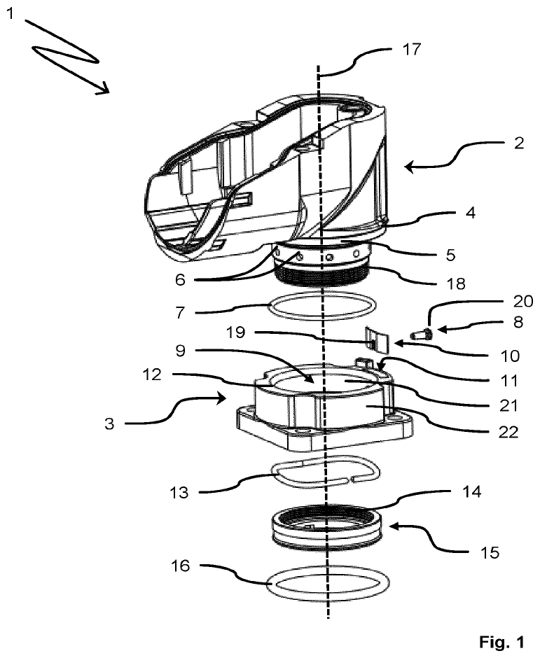

FIG. 1 shows an exploded view of an embodiment variant of an electrical connector 1 according to the invention. The illustration comprises only the most important elements of the electrical connector 1, which is designed as a right-angle connector. The electrical connector 1 comprises a first housing part 2 as part of a right-angle connector housing (not shown completely) and a second housing part 3, which is designed as a base or flange, so that the electrical connector 1 can be placed, for example, on a wall of a device housing via the second housing part 3 and can be fastened to the wall, for example, by means of screw connections.

The first housing part 2 and the second housing part 3 are rotatable relative to each other about an axis of rotation 17. If the second housing part 3 is fastened, as mentioned, for example to a device housing, only the first housing part 2 is rotatable about the axis of rotation 17 relative to the second housing part 3. In the assembled state, the first housing part 2 engages, from the lower axial end with the circumferential external thread 18 up to the circumferential shoulder 4, designed as an abrupt enlargement of the outer radius of the first housing part 2 in the axial direction, with the inner cavity 9 of the second housing part 3 extending completely through the second housing part 3 in the axial direction. In this case, the lower edge of the shoulder 4 forms a stop which rests on the upper edge 12 of the second housing part 3. The first housing part 2 is rotationally symmetrical in the region from the lower end of the first housing part 2 with the external thread 18 up to the shoulder 4. An outer circumferential recess 5 for receiving an O-ring 7 is formed on the first housing part 2 below the shoulder 4.

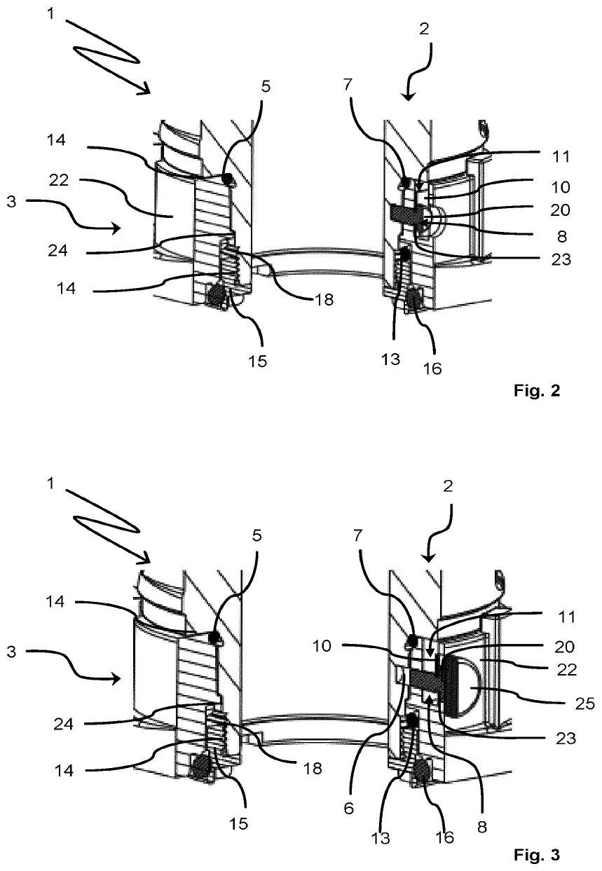

The shoulder 4 of the first housing part 2 as a stop and the upper edge 12 of the second housing part 3 as a counter-stop form part of the axial fixing of the first housing part 2 and the second housing part 3 to each other parallel to the axis of rotation 17. According to the exemplary embodiment shown in the figures, the other part of the axial fixing comprises a partially ring-shaped (i.e., having an open annular shape) wire spring 13 and a fixing ring 15. In alternative embodiments of the invention, the wire spring 13 can also be dispensed with, since it is only used for the purpose of damping and is not essential for the execution of the invention. A rubber bearing or a punched spring can alternatively also be used for damping. The fixing ring 15 has an internal thread 14 corresponding to the external thread 18 of the first housing part 2 for forming a screw connection between the first housing part 2 and the fixing ring 15. The wire spring 13 is disposed between the upper side of the fixing ring 15 and a shoulder 24, which is not visible in FIG. 1 but in the sectional views in FIGS. 2 and 3, as a stop which is formed as a circumferential abrupt diminution of the radius of the inner cavity 9 in the axial direction in the inner cavity 9 of the second housing part 3. The fixing ring 15 fastened by means of a screw connection on the first housing part 2, the wire spring 13, and the shoulder 24 for the wire spring 13 in combination with the fixing ring 15 define, together with the shoulder 4 of the first housing part 2 and the upper edge 12 of the second housing part 3, the first housing part 2 and the second housing part 3 in both possible axial directions parallel to the axis of rotation 17. The wire spring 13 is clamped between the fixing ring 15 and the shoulder 24, and the first housing part 2 and the second housing part 3 are thus preloaded relative to each other in the axial direction parallel to the axis of rotation 17. A further O-ring 16 is disposed in a channel (not visible in FIG. 1, but visible—though not marked—in FIGS. 2 and 3), which is open at the bottom and formed between the locking ring 15 and the second housing part 3.

Radial recesses 6 are formed in the first housing part 2 in a circumferential region between the external thread 18 and the circumferential recess 5 for receiving the O-ring 7. The radial recesses 6 are disposed equidistantly along the circumference of the first housing part 2 and are all identical. The radial recesses 6 serve to receive the end of a bolt 8 in the form of a cylindrical stud with a preferred stud longitudinal axis and with a head 20 on one of the two lengthwise ends of the stud. The bolt 8 is made of a ferromagnetic and/or permanent magnetic material. The head 20 of the bolt 8 together with a leaf spring 10 is mounted in a pocket 11 formed at the radial edge region of the second housing part 3 between an outer wall 22 of the second housing part 3 and the inner wall 21, which extends around the inner cavity 9 of the second housing part 3. The leaf spring 10 has a linear slot 19 extending from a long longitudinal side of the leaf spring 10 into a central region of the leaf spring 10. Alternative embodiments of the invention can comprise differently designed spring elements, for example a spiral spring. The bolt 8 has a constriction 23 in the form of a circumferential recess in the longitudinal direction adjoining its head 20 (see in particular FIGS. 2 and 3). The diameter of the constriction 23 corresponds to the width of the slot 19 of the leaf spring 10. The slot 19 of the leaf spring 10 is rounded at its end in the central region of the leaf spring 10 commensurate to the outer radius of the bolt 8 in the region of the constriction 23. The leaf spring 10 engages around the bolt 8 with the two flanks on the longitudinal sides of the slot 19, wherein the bolt 8 is seated with its constriction 23 in the slot 19 of the leaf spring 10. As a result, the leaf spring 10 and the bolt 8 are fixed to each other. The bolt 8 extends in the radial direction through a corresponding recess in the partition wall of the second housing part 3 between the pocket 11 and the inner circumferential wall 21 into the inner cavity 9 and further into one of the radial recesses 6 of the first housing part 2. The recesses 6 and the bolt 8, in particular the second lengthwise end which is opposite the (first lengthwise) end with the head 20, are correspondingly matched to each other.

As can be seen, in particular, from the detail sectional view in FIG. 2, the first housing part 2 and the second housing part 3 are secured against rotation relative to each other about the axis of rotation 17 when the second lengthwise end of the bolt 8 is engaged with one of the recesses 6. The leaf spring 10 is mounted so as to be preloaded in the pocket 11 such that a permanent spring force on the bolt 8 results in the radial direction towards the axis of rotation 17 in the center. This ensures that the bolt 8 remains in such a first basic state or locking state by default. By application of a magnetic force which overcompensates the spring force of the leaf spring 10, the bolt 8 can be transferred from such a first basic state or locking state into a second basic state or release state. The bolt 8, in particular as regards its second end, is moved in the radial direction against the spring force so far that the bolt 8 is disengaged from the first housing part 2 or each one of the radial recesses 6 of the first housing part 2. Thus, a completely free rotation of the first housing part 2 and the second housing part 3 relative to each other about the axis of rotation 17 is possible. To transfer the bolt 8 from a locking state to a release position, a permanent magnet 25, as shown in the detail sectional view in FIG. 3, can be guided to the outer side of the partition wall between the pocket 11 and the outer circumferential wall 22 of the second housing part 3. When different magnetic poles of the permanent magnet 25 and of the bolt 8 are aligned with one another in order to produce an attractive magnetic interaction and corresponding application of force between the bolt 8 and the permanent magnet 25, the spring force of the leaf spring 20 is overcompensated. As a result of the attractive magnetic interaction between the permanent magnet 25 and the bolt 8, the permanent magnet 25 remains at its position shown in FIG. 3 on the outer circumferential wall 22 of the second housing part 3—without the need to explicitly provide means for (temporary, releasable) fixing of the permanent magnet 25 on the second housing part 3—until the permanent magnet 25 is removed again from the relevant position by means of external engagement. Meanwhile, the first housing part 2 and the second housing part 3 can be freely rotated relative to each other about the axis of rotation 17. However, the first housing part 2 and the second housing part 3 cannot be secured against rotation relative to each other about the axis of rotation 17 in just any position or angular position. This is predetermined or limited by the number of radial recesses 6 and their distribution along the outer circumference of the first housing part 2.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Electrical connector
2 First housing part
3 Second housing part
4 Shoulder
5 Annular recess
6 Radial recess
7 O-ring
8 Bolt
9 Inner cavity of second housing part
10 Leaf spring
11 Pocket
12 Upper edge of second housing part
13 Wire spring
14 Internal thread
Fixing ring
16 O-ring
17 Axis of rotation
18 External thread
19 Slot of leaf spring
20 Head of bolt
21 Inner wall of second housing part
22 Outer wall of second housing part
23 Constriction of bolt
24 Shoulder of second housing part
25 Permanent magnet

1: An electrical connector, comprising:
at least a first housing part and a second housing part, nan engagement region of one of the first housing part and the second housing part being configured to engage at least partially and concentrically with an other of the first housing part and the second housing part, the first housing part and the second housing part are configured to be rotatable in the engagement region relative to each other about an axis of rotation;
at least one bolt disposed in the engagement region, which in a first basic state secures the first housing part and the second housing part against rotation of the housing parts relative to each other about the axis of rotation, and in a second basic state releases the housing parts,
wherein the at least one bolt is magnetic and preloaded by a spring force, and a transition of the bolt from a first basic state to a second basic state is inducible by application of a magnetic force to the at least one bolt.

2: The electrical connector of claim 1, wherein the at least one bolt extends in the first basic state in a radial direction through a corresponding radial feedthrough from the housing part located outside in the engagement region into an inner cavity of an outside housing part and further extends at least partially into a corresponding radial recess in the housing part located inside in the engagement region.

3: The electrical connector of claim 2, wherein the housing part located inside in the engagement region has a plurality of radial recesses disposed along an outer circumference thereof.
